(19) United States
(12) Patent Application Publication
(10) Pub. No.: US 2006/0072039 A1
(43) Pub. Date: Apr. 6, 2006

(54) Display apparatus for generating a sync start point

(76) Inventor: Hong-ju Na, Suwon-si (KR)

Correspondence Address: MCGUIREWOODS, LLP, 1750 TYSONS BLVD, SUITE 1800, MCLEAN, VA, 22102, US

(21) Appl. No.: 11/214,788

(22) Filed: Aug. 31, 2005

(30) Foreign Application Priority Data
Sep. 1, 2004 (KR) 2004-0069538

(51) Int. Cl. H04N 5/06

(52) U.S. Cl. 348/540; 348/521

(57) ABSTRACT

A display apparatus displaying an image, the display apparatus including a video signal receiver receiving a video signal comprising a sync signal, a sync delaying buffer delaying the sync signal from the video signal receiver at a predetermined interval, a logic calculator outputting a corrected sync signal by logically calculating the sync signal from the video signal receiver and the sync signal delayed by the sync delaying buffer at the predetermined interval, and a start point generator generating a sync start point on the basis of the corrected sync signal output from the logic calculator.

### CROSS-REFERENCE TO RELATED APPLICATIONS

This application claims the benefit of Korean Patent Application No. 2004-0069538, filed on Sep. 1, 2004, which is hereby incorporated by reference for all purposes as if fully set forth herein.

### BACKGROUND OF THE INVENTION

1. Field of the Invention

The present invention relates to a display apparatus, and more particularly, to a display apparatus capable of generating a constant sync start point according to a sync signal.

2. Description of the Related Art

A display apparatus typically displays an image by receiving a video signal in a predetermined display mode from a video signal source such as a computer, a TV broadcasting system, etc. The display apparatus may be a CRT (cathode ray tube) or a flat panel display, such as an LCD (liquid crystal display), a PDP (plasma display panel), etc.

Unlike the display apparatus using the CRT, a flat panel display apparatus receives an analog video signal from a video signal source, and converts the analog video signal received from the video signal source to a digital video signal to display an image. The analog video signal is converted to the digital video signal by an A/D converter provided in the flat panel display apparatus. The converted digital video signal then passes through a phase of processing a signal, which is set in advance, and the processed signal is then supplied to an LCD panel or the PDP to drive a unit pixel respectively corresponding on a screen, thereby displaying the image.

The display apparatus separates a horizontal sync signal and a vertical sync signal included in the video signal and adjusts a horizontal and vertical position of the image and a start point and an end point of the video signal according to the horizontal sync signal and the vertical sync signal.

The display apparatus generates a sync start point according to the horizontal sync signal and the vertical sync signal, and determines a point from which the image is started from among the video signals.

However, when an imperfect sync signal, particularly an imperfect horizontal sync signal, is input to the display apparatus, the display apparatus cannot generate an exact sync start point. Accordingly, a part of the image displayed on the display apparatus is inclined or angled to one side, thereby causing the image to be distorted.

### SUMMARY OF THE INVENTION

Accordingly, it is an aspect of the present invention to provide a display apparatus generating a constant sync start point when an imperfect sync signal is input thereto.

Additional aspects and/or advantages of the present invention will be set forth in part in the description which follows and, in part, will be obvious from the description, or may be learned by practice of the present invention.

The invention provides for a display apparatus displaying an image, the display apparatus including a video signal receiver receiving a video signal comprising a sync signal, a sync delaying buffer delaying the sync signal from the video signal receiver at a predetermined interval, a logic calculator outputting a corrected sync signal by logically calculating the sync signal from the video signal receiver and the sync signal delayed by the sync delaying buffer at the predetermined interval, and a start point generator generating a sync start point according to the corrected sync signal output from the logic calculator.

The invention further provides a sync signal processor processing a sync signal for a display apparatus, including a sync delaying buffer receiving the sync signal and delaying the received sync signal for a predetermined interval, a logic calculator receiving the sync signal and the delayed sync signal, logically summing an adjacent field of the sync signal and the delayed sync signal, and outputting a corrected sync signal, and a start point generator generating the sync start point according to the corrected sync signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a control block diagram of a display apparatus according to an embodiment of the invention;

FIG. 2 is a control block diagram of a sync signal processor of the display apparatus shown in FIG. 1; and

FIG. 3 is a timing diagram of a horizontal sync signal of the display apparatus according to an embodiment of the invention.

### DETAILED DESCRIPTION OF THE ILLUSTRATED EMBODIMENTS

Reference will now be made in detail to the embodiments of the present invention, examples of which are illustrated in the accompanying drawings, wherein like reference numerals refer to like elements throughout.

As shown in FIG. 1, a display apparatus according to an embodiment of the invention includes a video signal receiver 10, a video signal processor 20, a sync signal processor 40, and a display module 30.

The video signal receiver 10 receives an analog video signal from a video signal source, such as a computer, etc. The video signal receiver 10 may include various connectors to receive video signals in various forms. For example, the video signal receiver 10 may include at least one of a D-Sub connector, a CVBS (composite video broadcast signal) connector, an S-video connector and a component connector to receive the analog video signal.

The analog video signal supplied from the video signal receiver 10 includes analog video data, a horizontal sync signal and a vertical sync signal. In addition, the video signal receiver 10 separates the supplied video signal into the analog video data, the horizontal sync signal, and the vertical sync signal, and then outputs the analog video data, the horizontal sync signal, and the vertical sync signal.

The video signal processor 20 receives the analog video data, the horizontal sync signal, and the vertical sync signal from the video signal receiver 10, and converts the analog video data, the horizontal sync signal, and the vertical sync signal into a format capable of being processed by the display module 30. According to an embodiment of the invention, the video signal processor 20 may include an A/D converter converting the analog video data into the digital video data; and a scaler scaling the digital video data converted by the A/D converter to be processed by the display module 30 according to the format, e.g. a resolution, and the like.

The display module 30 displays the image according to the digital video data, the horizontal sync signal and the vertical sync signal, which are converted by the video signal processor 20. An LCD (liquid crystal display) module is described below as a non-limiting example of the display module 30 according to an embodiment of the invention.

The sync signal processor 40 generates a sync start point by receiving the horizontal sync signal and the vertical sync signal output from the video signal receiver 10. The sync start point generated by the sync signal processor 40 is supplied to the video signal processor 20, and used for detecting an actual start point of the video data to display an actual image among the video data.

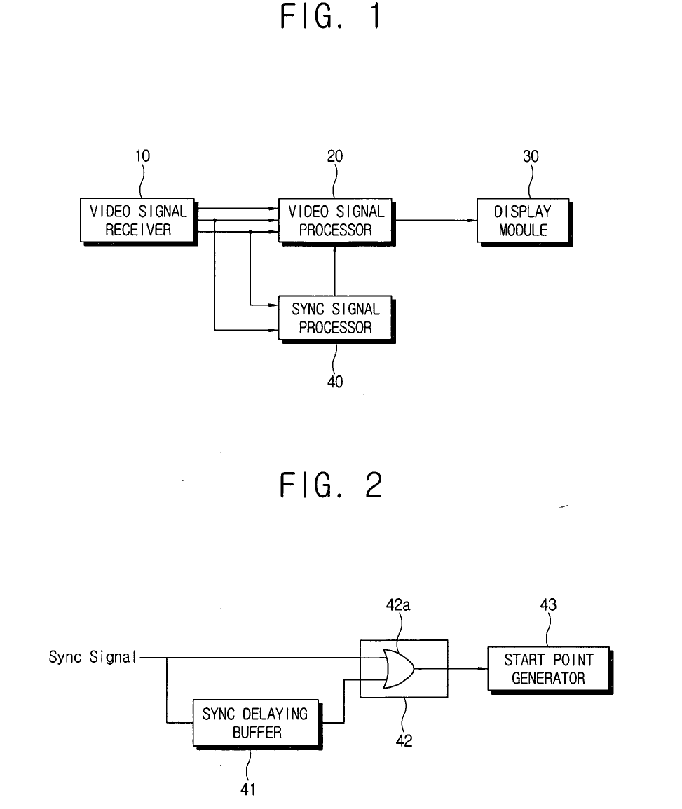

FIG. 2 shows a non-limiting example of the sync signal processor 40 according to an embodiment of the invention. As shown therein, the sync signal processor 40 includes a sync delaying buffer 41, a logic calculator 42, and a start point generator 43. For example, the horizontal sync signal may be processed by the sync signal processor 40 and the vertical sync signal may be applied the same as the horizontal sync signal.

The sync delaying buffer 41 delays the horizontal sync signal from the video signal receiver 10 at a predetermined interval, and then outputs the horizontal sync signal. The sync delaying buffer 41 may temporarily store the horizontal sync signal by field, and delay the horizontal sync signal by the field. Similarly, the sync delaying buffer 41 may store and delay the horizontal sync signal according to a line or a frame.

After calculating, e.g., logically, the horizontal sync signal output from the video signal receiver 10 and the horizontal sync signal delayed by the sync delaying buffer 41 at the predetermined interval, the logic calculator 42 outputs a corrected horizontal sync signal. Accordingly, the logic calculator 42 may include an OR-Gate 42a to logically calculate the two horizontal sync signals.

The sync delaying buffer 41 may send the horizontal sync signal at an N'th field to the logic calculator 42 when the video signal receiver 10 sends the horizontal sync signal at an N+1th field to the logic calculator 42. Thus, the logic calculator 42 logically sums the two horizontal sync signals at the fields adjacent to each other.

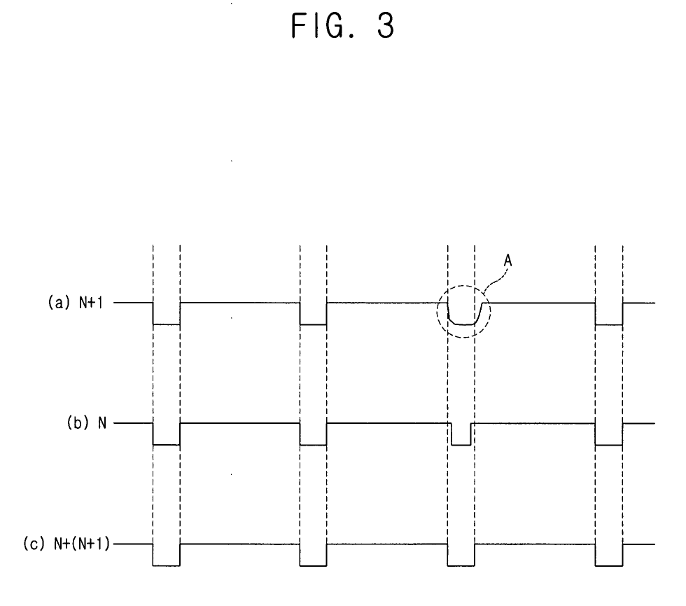

FIG. 3 is a timing diagram illustrating a relationship between a portion (refer to FIG. 3 (a)) of the horizontal sync signal at the N+1th field output from the video signal receiver 10 and a portion (refer to FIG. 3 (b)) of the horizontal sync signal at the Nth field output from the sync delaying buffer 41. As shown therein, when an imperfect horizontal sync signal A exists in the horizontal sync signal at the N+1th field input from the video signal receiver 10, the imperfect horizontal sync signal A is corrected by the horizontal sync signal at the Nth field output from the sync delaying buffer 41, and a waveform of the horizontal sync signal such as (c) in FIG. 3 is generated.

The start point generator 43 receives the corrected horizontal sync signal from the logic calculator 42, and generates the sync start point. The sync start point generated by the start point generator 43 is supplied to the video signal processor 20 and used for detecting the start point having actual video information among the video data.

In the embodiment of the invention discussed above, the logic calculator 42 may include an OR-Gate 42a. The logic calculator 42 may further include various circuit configurations as long as the logic calculator receives two logic signals and outputs a result of the logical sum.

By providing the video signal receiver 10 receiving the video signal including the sync signal, the sync delaying buffer 41 delaying the sync signal from the video signal receiver 10 at the predetermined interval, the logic calculator 42 logically calculating the sync signal from the video signal receiver 10 and the sync signal delayed by the sync delaying buffer 41 at the predetermined interval and outputting the corrected sync signal, the start point generator 43 generating the sync start point according to the corrected sync signal output from the logic calculator 42, the display apparatus generates the constant sync start point even when the imperfect sync signal is input thereto.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus displaying an image, comprising:
a video signal receiver receiving a video signal comprising a sync signal;
a sync delaying buffer delaying the sync signal from the video signal receiver at a predetermined interval;
a logic calculator outputting a corrected sync signal by logically calculating the sync signal from the video signal receiver and the sync signal delayed by the sync delaying buffer at the predetermined interval; and
a start point generator generating a sync start point according to the corrected sync signal output from the logic calculator.

2. The display apparatus of claim 1, wherein the sync delaying buffer temporarily stores and delays the sync signal by field.

3. The display apparatus of claim 2, wherein the sync delaying buffer outputs the sync signal at an Nth field to the logic calculator when the logic calculator receives the sync signal at an N+1th field from the video signal receiver.

4. The display apparatus of claim 1, wherein the sync signal comprises a horizontal sync signal.

5. The display apparatus of claim 2, wherein the sync signal comprises a horizontal sync signal.

6. The display apparatus of claim 3, wherein the sync signal comprises a horizontal sync signal.

7. A sync signal processor processing a sync signal for a display apparatus, comprising:
a sync delaying buffer receiving the sync signal and delaying the received sync signal for a predetermined interval;
a logic calculator receiving the sync signal and the delayed sync signal, logically summing an adjacent field of the sync signal and the delayed sync signal, and outputting a corrected sync signal; and
a start point generator generating the sync start point according to the corrected sync signal and outputting the sync start point to a video signal processor of the display apparatus.

8. The sync signal processor of claim 7, wherein the sync signal comprises a horizontal sync signal.
